(19) United States
(12) Patent Application Publication
(10) Pub. No.: US 2013/0077731 A1
(43) Pub. Date: Mar. 28, 2013

(54) CERAMIC ENCAPSULATIONS FOR NUCLEAR MATERIALS AND SYSTEMS AND METHODS OF PRODUCTION AND USE

(71) Applicants: Walter J. Sherwood, Glenville, NY (US); Douglas Bruce Coyle, Aurora (CA)

(72) Inventors: Walter J. Sherwood, Glenville, NY (US); Douglas Bruce Coyle, Aurora (CA)

(73) Assignee: TORXX Group Inc., Richmond Hill, ON (CA)

(21) Appl. No.: 13/432,601

(22) Filed: Mar. 28, 2012

Related U.S. Application Data
(60) Provisional application No. 61/468,490, filed on Mar. 28, 2011.

(51) Int. Cl. G21C 3/07

(52) U.S. Cl. CPC G21C 3/07
USPC 376/417; 264/5

(57) ABSTRACT

A novel containment system for encapsulating nuclear fuel particles is disclosed. The containment system has a gas-impervious ceramic composite hollow shell having a spheroidal or ovoidal shape. The shell has a pair of longitudinally aligned round openings that are sealed with a gas-impervious ceramic composite tube to define a cavity between the shell inner surface and the tube outer surface. A ceramic composite matrix containing the nuclear fuel particles is enclosed within the cavity. The ceramic composite matrix has a controlled porosity, and can contain moderators or neutron absorbing material. The tube and shell are composed of a ceramic matrix composite material composed of ceramic reinforcement material that is bound together by a polymer-derived ceramic material.

### CROSS-REFERENCE TO RELATED APPLICATION

This application claims the benefit of U.S. Provisional Application No. 61/468,490, filed Mar. 28, 2011, the entirety of which are hereby incorporated by reference.

### BACKGROUND

The Primary Concern with conventional PWR and BWR reactors systems has always been containing the steam and hydrogen pressure generated in a loss of coolant accident (LOCA) . . . we all remember 3-Mile Island. Since conventional reactors rely on massive amounts of water to keep the zirconium clad fuel rods from melting, any significantly long interruption in the coolant flow can result in the core very rapidly heating enough to either produce high pressure steam in a BWR or high pressure hydrogen in a PWR. Even after a full SCRAM—full insertion of the control rods into the reactor to try to shut down the fission reaction (or at least slow it down), large amounts of residual heat is generated.

Events in Japan in 2011 highlight the clear and present danger of steam and hydrogen explosions breaching the containment structures. The majority of the current reactors in the US and most of the world were built using 1960's materials technology as well as mechanical/hydraulic control systems.

Conventional fuel containment materials have been primarily zirconium metal for water cooled reactors and graphite for high temperature gas reactors. Both materials have safety issues; zirconium reacts with steam to form hydrogen and becomes embrittled at pressurized steam pressures. Zirconium based reactor fuel is typically in the form of very long (12-16 ft) rods containing cylindrical pellets in a long ½″ to ¾″ diameter zirconium tube. Some other reactors in the old Soviet Union had the fuel imbedded in graphite. Some other designs were cooled with helium instead of water and used graphite balls or pebbles to contain the uranium fuel. Originally the pebbles were graphite since a moderator was needed, however, graphite fell out of favor after Chernobyl. It was found that graphite will burn and carry the fission products up with the smoke. The invention addresses these issues.

### BRIEF SUMMARY OF THE INVENTION

The present invention describes a novel ceramic composite based nuclear fuel containment structure. The structure and materials are non-reactive, strong at high temperatures, are radiation resistant, and do not require water-cooling to function safely. The invention embodies a novel containment structure in the form of an oval ceramic “bead” structure with an annulus through the center. The open center annulus permits dramatically improved heat transfer compared to standard “pebbles” used in pebble bed reactors. Further embodiments include the use of ceramic forming polymers to replace graphite as the primary structure of the bead. The ceramic formed from the polymers is silicon carbide (SiC) which is stable in water, steam, and very high temperature air, it will not burn like graphite or produce hydrogen like zirconium. The ceramic forming polymers also allow complete control of the amount of carbon (moderator) in the ceramic by altering the chemical structure of the polymer. The use of ceramic forming polymers also allows control of the size and amount of porosity in the bead interior. The porosity is needed to collect any fission gases that escape from the fuel particles. A further embodiment is the controlled and selected addition to sections of the bead of both “burnable” neutron absorbers such as boron 10 and non-burnable absorbers such as hafnium, erbium, and other high temperature stable materials. These materials would be added as mixtures with the ceramic forming polymer.

The fuel bead has the ability to function safely at temperatures up to 5 times higher than conventional water cooled reactors (for example: operation at 1,500 degrees Celsius compared to operation limited to about 300 degrees Celsius in a conventional reactor), but without the threat of burning seen with graphite based fuel containing pebbles. A further advantage of this invention is the improved heat transfer out of the fuel bead due to the hollow tube running lengthwise down the center of the bead that prevents the heat build-up seen in solid spherical fuel pebbles and allows higher fuel loading.

The outer shell and inner annular tube would be hermetically sealed to contain any fission products in the porous matrix. This would prevent fission product release in the event of loss of coolant.

According to one aspect, a nuclear fuel containment system for encapsulating nuclear fuel particles is provided having a gas-impervious ceramic composite shell , the shell inner surface defining a cavity, and a ceramic composite matrix having a controlled porosity containing the nuclear fuel particles is provided within the cavity. In another aspect, the shell has a top portion and a bottom portion each defining a ring aligned about a center of the shell, and a gas-impervious ceramic composite tube is sealed to a corresponding ring of the shell to further define the cavity between the shell inner surface and the tube outer surface. The shell can have spherical, ovoidal or elliptical shape. In some aspects, the ceramic composite matrix is comprised of a material formed by pyrolysis of a ceramic forming polymer. In another aspect, the shell and the tube are comprised of a radiation resistant high temperature ceramic material. The radiation resistant high temperature ceramic material can include any one silicon carbide (SiC); zirconium carbide (ZrC); and aluminum oxide. In yet another aspect, the ceramic composite matrix is formed by pyrolysis of polymer precursors to produce any one of silicon carbide (SiC), zirconium carbide (ZrC), titanium carbide, silicon nitride, and aluminum oxide. In a still further aspect, the ceramic composite matrix can include moderators or neutron absorbers distributed through the ceramic composite matrix. The moderators can be carbon and the neutron absorbers can be any one or more of boron carbide, hafnium carbide, hafnium diboride, erbium oxide or hafnium oxide. In some aspects, the shell and the tube can include reinforcement materials in the form of any one of: continuous fibers, chopped fibers, milled fibers, powder, platelets and whiskers. The reinforcement materials can be selected from any one of: silicon carbide, zirconium carbide, graphite, titanium carbide, beryllium oxide, boron carbide, and silicon nitride. The reinforcement materials are bonded together by ceramic material formed by the pyrolysis of a ceramic forming polymer to form a ceramic matrix casing or shell. The reinforcement materials can be further bonded together and sealed by chemical vapor deposition of a ceramic material. In some aspects, the ceramic matrix casing is comprised of any one of: silicon carbide, silicon carbide containing excess carbon, zirconium carbide, zirconium carbide containing excess carbon, boron carbide, and boron carbide containing excess carbon. In still yet another aspect, the ceramic composite matrix is non-burning. In other aspects, the controlled porosity of the ceramic composite matrix can include nano-porosity and micro-porosity. In some aspects, the ceramic composite matrix comprises a ceramic material produced by pyrolysis of a ceramic forming polymer mixed/blended or reacted with one or more non-polymer derived ceramic materials, where the ceramic material can be one or more of: silicon carbide, silicon carbide containing excess carbon, zirconium carbide, zirconium carbide containing excess carbon, boron carbide, and boron carbide containing excess carbon. The non-polymer derived ceramic materials can be one or more of: chopped fibers, milled fibers, powder, platelets and whiskers, and can be one or more of: silicon carbide, silicon nitride, boron carbide, alumina, carbon, graphite, and titanium carbide. In some aspects, the ceramic composite matrix includes at least one neutron absorbing ceramic material that can be any one of: boron carbide, hafnium carbide, hafnium diboride, titanium diboride, and erbium oxide. In yet another aspect, the ceramic composite matrix can include a neutron reflecting segment that is compose of neutron reflecting ceramic material that can be adjacent to one of the outer tube surface and the inner shell surface.

According to another aspect, there is provided a method of manufacturing a nuclear fuel containment system for encapsulating nuclear fuel particles, the method comprising providing ceramic fiber on a cylinder, a first half-shell mold and a second half-shell mold; coating the ceramic fiber with a slurry of ceramic forming polymer and silicon carbide ceramic powder; pyrolysing the coated ceramic fiber to produce two ceramic composite shell halves and a ceramic composite tube; sealing the two ceramic composite shell halves and the ceramic composite tube; and providing a ceramic composite matrix containing nuclear fuel particles within the two ceramic composite shell halves.

### DETAILED DESCRIPTION OF THE INVENTION

The invention discloses a nuclear-fuel-encapsulating structure or bead shown in FIG. 1.

The encapsulating bead consists of the following attributes:
1. A sealed gas-impervious outer ceramic shell.
2. A sealed gas-impervious inner ceramic tube.
3. A nano-porous ceramic matrix with controlled carbon content to hold the fuel particles (the recommended fuel particles are either “TRISO” or “BISO” multilayer encapsulated uranium oxide/carbide particles typically produced by fluidized bed coating processes).
4. Selected regions of neutron absorbing “poisons” to enhance uniformity of the “burn-up” or fissioning of the primary fissionable fuel material, such as uranium, thorium or plutonium.
5. Other structures such as regions of higher carbon content to help control the burn-up.

The gas-impervious outer shell is composed high temperature-stable, radiation-resistant silicon carbide (SiC). The shell can be produced using a number of processes such as Chemical Vapor Deposition (CVD), Reaction bonding, or by densification of a ceramic forming polymer-based slurry. This shell would typically be between 0.040″ (1 mm) and 0.5″ (13 mm) in thickness, depending on the design parameters. The shell could contain reinforcement to improve strength and shock resistance. The reinforcement would be one of the following, braided SiC or alumina fiber, chopped SiC or alumina fiber, or milled SiC or alumina fiber. The matrix of the shell would be SiC applied as a pre-ceramic polymer slurry, CVD silicon carbide or a combination thereof. Reaction bonding with molten silicon to form the silicon carbide matrix is also a viable method.

The sealed gas-impervious inner tube would be composed of one or more of the materials utilized for the gas-impervious outer shell. The inner tube surface could be roughened to improve heat transfer to the gas. The surface would be inherently rough if the inner tube was composed of braided SiC or alumina fiber. The thickness of the inner gas-impervious tube would range from roughly 0.020″ (0.5 mm) to 0.25″ (6 mm).

The nano-porous ceramic matrix would be composed of polymer derived SiC ceramic, which inherently forms a nano-porous matrix. The polymer would be blended with SiC powder to provide strength in the ceramic and help form microporosity. If needed, carbon powder or milled/chopped fibers would function as a moderator. The ceramic forming polymer would also be modified so as to produce high carbon SiC, which would also function as a moderator. The heat treatment (and neutron flux) would stabilize the structure to SiC ceramic with evenly dispersed nano-scale graphite nodules that would provide uniform moderation without the swelling issues of bulk graphite.

The preferred fuel particles for this invention would be uranium oxide/uranium carbide blended fuel particles coated with multiple layers of fission product absorbing porosity and gas-impervious SiC or boron carbide. The generic terms for such particles are “TRISO” or “BISO” fuel particles; these particles were designed for High Temperature Gas Reactors (HTGRs) that relied on helium to function as the coolant/energy transfer medium. TRISO particles would be imbedded in the non-burning moderated ceramic “beads”. TRISO particles were developed to contain fission products in each individual fuel particle. The TRISO particle shells can function as the First Containment. The attainable design criterion for the TRISO particles was typically one failed particle per 100,000 particles. There would be millions of fuel particles in a reactor, so containment beads would function as a secondary and tertiary containment for the imbedded TRISO particles.

It would also be feasible to form small spheres, rods, or other shapes of pre-formed “bare” fuel particles bonded with ceramic forming polymer into compacts. These compacts would be sealed in their own small containment and then imbedded in the larger fuel bead matrix.

The ceramic forming polymer would also be combined with ceramic powders containing neutron absorbing elements “poisons” such as boron in the form of boron carbide, hafnium as hafnium oxide, carbide or diboride, erbium as erbium oxide, and nearly any other neutron absorbing element that forms a high temperature stable compound. The poisons could be distributed during the bead molding process as well as during the bead matrix densification process. The bead can also have “molded in” regions of more moderator, regions of more burnable poisons such as boron carbide to help optimize “burn-up” as well as molded in neutron reflectors such as boron¹¹ carbide, or beryllium oxide.

### Example

### One Ceramic Composite Fuel Bead Manufacturing Route

One possible route to manufacturing of the fuel beads would be to make outer and inner gas-impervious component separately away from the radioactive fuel. An example bead fabrication route is provided:

Outer shell and Inner Tube Fabrication:

The inner tube would be molded in two separate tubes of lengths equivalent to roughly ⅔ of the desired inner tube length that would be bonded together during the bead assembly. Each tube would have a flared end to assist in bonding to the outer shell, with the other ends molded/machined to provide a joint that could be assembled and sealed/bonded during bead assembly. The tubes would be made by sliding a braided tube of SiC or other ceramic fiber onto a mandrel of a diameter equivalent to the desired inner tube diameter. The ceramic fiber tube would be composed of at least two and no more than 6 layers of braided ceramic tubing that were coated with a slurry of ceramic forming polymer and silicon carbide ceramic powder. The tube would then be pyrolyzed to at least 1000° C. in inert gas and held for at least 1 hour to produce a ceramic composite preform of the inner tube. The tube would be vacuum reinfiltrated and pyrolysed between three and six more times to produce a dense tube. The outer ovoid shell would be made in a similar manner only the shell would be made in two halves to permit loading with the ceramic matrix/fuel particles. Each half of the ovoid would be molded separately mandrel tube or rod in place of the eventual gas-impervious tube. Each half of the fuel bead shell would be composed of biaxially braided SiC fibers that would be coated with a slurry of chopped and milled SiC ceramic fibers and SiC powder mixed into a SiC forming polymer such as CS-160 from EEMS, LLC. The slurry coated braided fabric would be pressed in a near net shape male/female two part mold to compress the shell and attain the 40-45% fiber volume needed for strength and density.

The shell would be pyrolyzed to a temperature of at least 1000° C. for 1 hour in inert gas to form the outer shell preform. The shell preform halves would then be bonded to their matching inner tubes by attaching the flared tube end to the hole in the smaller diameter end of the shell using applying a ceramic forming polymer-based adhesive slurry containing ceramic powder. The joined bead preform shell halves would then be densified by vacuum infiltration and pyrolysis to 1000° C. between three and six more times to produce the ½ sections of the outer shell of the bead.

Fuel Particle Containing Matrix Fabrication

The fuel particle matrix would be made by blending TRISO or BISO type fuel particles into a “molding compound” containing ceramic powders of various sizes to provide structure, some chopped or milled carbon fiber to provide moderator, and whatever amounts of poison and reflector materials deemed necessary by the designers. The molding compound fibers and powders would be blended with a liquid ceramic-forming polymer to form a moldable soft “clay-like” material.

Fuel Bead Component Assembly

The fuel bead containing matrix clay would be tamped into the already fabricated half bead components using sufficient pressure to force the matrix clay into the shell cavity. A ceramic adhesive slurry would then be painted onto all bonding surfaces, including the top surface of each bead matrix, the shell rims, and the bonding region of the inner composite tubes. The mating bead halves would then be pushed together to form the bead. The excess adhesive slurry would be forced out and form a ring around the middle of the bead. The excess slurry would be wiped off to make a smooth bonding region and the assembled bead would then go through the same cure and pyrolysis cycle used to fabricate the shell and inner tube sections. After pyrolysis, the entire bead surface and tube inner diameter would be painted with a “seal coat” of ceramic powder containing ceramic forming polymer to fill in any pores in the surfaces, the painted bead would then be cured and pyrolyzed. The bead would then be dipped in ceramic forming polymer, cured, and pyrolyzed 3 more times to complete formation of the gas-impervious outer shell and tube. Alternatively, chemical vapor deposition of silicon carbide or zirconium carbide can be used to seal the bead in place of the final three dip coatings and pyrolysis cycles.

A similar, but simpler procedure can be used to fabricate smaller (1 inch diameter or less) fuel pebbles using ceramic composite fabrication technology described above but only making ½ spherical shells without holes in the shells. In this embodiment, the fuel particle containing clay from above would simply be packed into the hollow half-sphere shells and the shells bonded together with the ceramic forming polymer based adhesive as in the previous embodiment. The sealing process(s) could also be the same.

As a further example of the invention: uncoated fuel particles could be mixed with a ceramic matrix to form a molding compound that would be formed into small (½ diameter rods or other configurations such as spheres (¼ inch to ½″ diameter maximum), the rods or spheres would then be sealed within individual small ceramic composite containment shells. These shells would then be molded or placed into the ceramic composite matrix of the larger fuel beads described in the first example and the fuel bead could then be assembled and sealed as described in the first example.

### BRIEF DESCRIPTION OF THE FIGURES

FIG. 1 shows a ceramic composite fuel bead completely fabricated.

1-1 is the outer gas-impervious composite shell

1-2 is the gas impervious composite inner tube

FIG. 2

2-1 is the outer gas-impervious composite shell

2-2 is the gas impervious composite inner tube

2-3 is the open cooling channel running through the bead

2-4 is the porous ceramic composite matrix containing the fuel particles

2-5 is a fuel particle imbedded in the composite matrix

FIG. 3

3-1 is a fuel particle imbedded in the porous ceramic composite matrix “A”

3-2 is a nano-pore

3-3 shows micro-pores

3-4 shows a neutron absorbing poison or moderator segment

FIG. 4

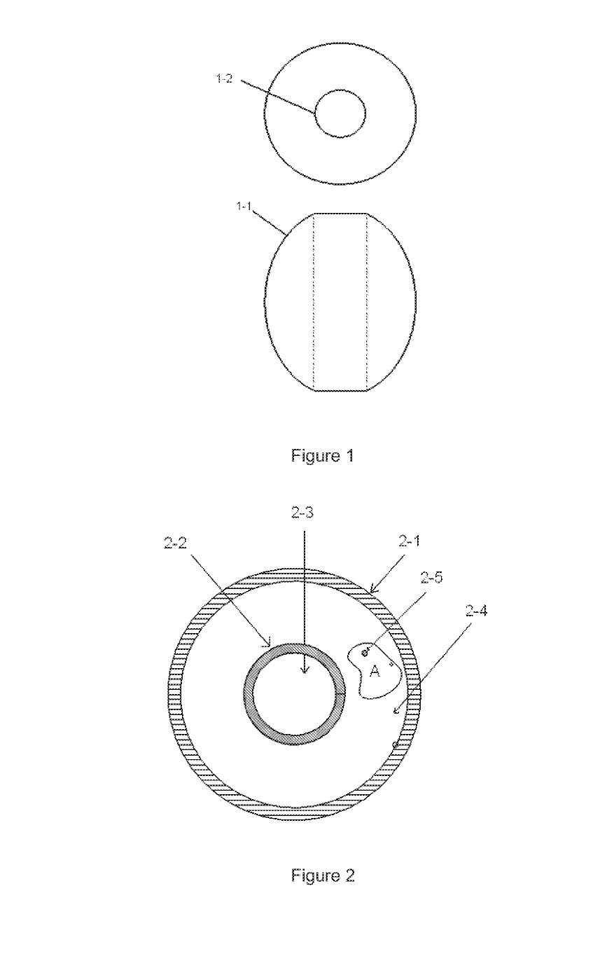

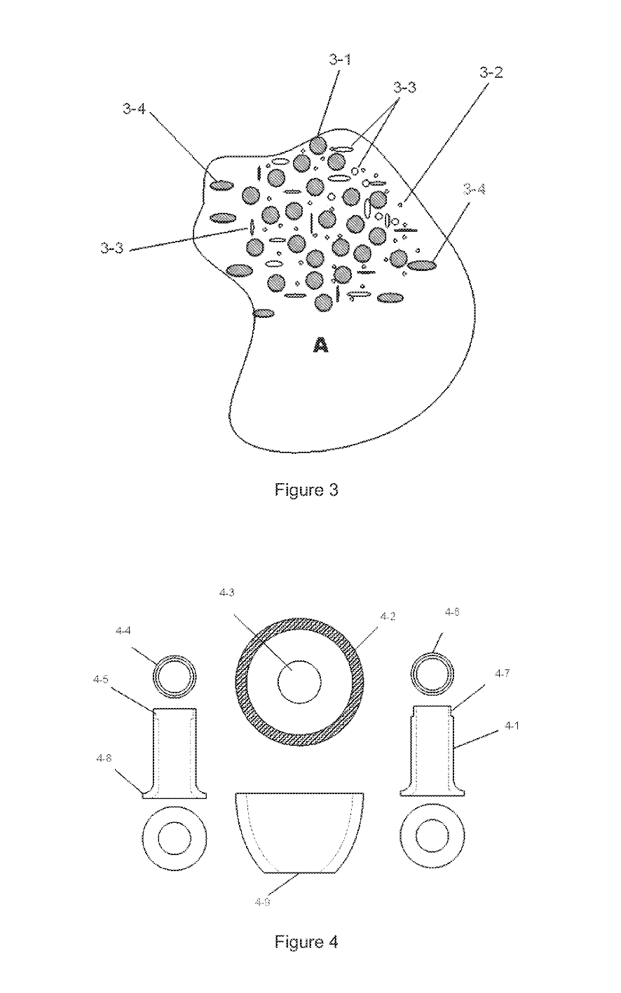

4-1 shows a ½ tube segment preform

4-2 shows the bonding surface of a half-segment of the fuel bead outer shell

4-3 is the opening in the fuel bead shell at the smaller diameter end also indicated by 4-9

4-4 is the cross-section of the “female” joint section of the composite tube preform half-segment

4-5 is the side view of the “female” joint section of the composite preform

4-6 is the cross-section view of the “male” joint section of the composite tube preform half-segment

4-7 is the side view of the “male” joint section of the composite tube preform half-segment

4-8 is the flared end of the composite tube preform half segment that would be joined to the outer shell half-segment in the region indicated by 4-9

4-9 indicates the section of the ceramic composite shell where the flared section of the inner composite tube preform will be joined using the ceramic forming polymer adhesive

Various Features and Aspects of Embodiments are Enumerated as Follows:
1. A ceramic composite fuel containment sphere or ovoid shaped bead comprised of a gas-impervious ceramic composite shell, a gas-impervious open tube down the center, and a controlled porosity ceramic composite matrix containing uranium or plutonium based fuel particles.
2. The ceramic composite matrix materials are composed of ceramics derived from the pyrolysis of ceramic forming polymers in either inert gas or air.
3. The ceramic composition is composed of one or more of the following: silicon carbide (SiC), zirconium carbide (ZrC), Aluminum oxide, or other radiation resistant high temperature ceramic material.
4. The ceramic composition of the matrix is formed by pyrolysis of polymer precursors to one or more of the following: silicon carbide (SiC), zirconium carbide (ZrC), titanium carbide, silicon nitride, aluminum oxide, or other radiation resistant high temperature ceramic material.
5. The ceramic composition of the matrix is formed by pyrolysis of polymer precursors formulated to produce controlled amounts of carbon or boron in order to produce uniformly distributed moderators or neutron absorbers on a nano-scale in the ceramic matrix.
6. The ceramic composite reinforcement is in the form of continuous ceramic fibers, chopped ceramic fibers, milled ceramic fibers, powders, or platelets.
7. The ovoid maximum length ranges from 1 inch to 12 inches and the length to diameter ratio ranges from 1:1 up to 4:1 and preferably 1:1 to 2:1.
8. The outer gas-impervious composite shell has a thickness from 0.040 inches (1 mm) to 0.5 inches (13 mm) depending on the size of the containment sphere—in general, the larger the containment bead, the thicker the gas-impervious composite shell.
9. The gas-impervious outer shell is composed of one or more of the following reinforcements imbedded in a ceramic matrix produced by the pyrolysis of one or more ceramic forming polymers: continuous fibers, chopped fibers, milled fibers, powder, platelets or whiskers.
10. The gas-impervious outer shell reinforcement materials are one or more of the following silicon carbide, zirconium carbide, graphite, titanium carbide, beryllium oxide, boron carbide, silicon nitride.
11. The gas-impervious outer shell has a ceramic matrix encasing and bonding the reinforcement that is comprised of ceramic material formed by the pyrolysis of one or more ceramic forming polymers to create one or more of the following matrix/sealing materials: silicon carbide, excess carbon containing silicon carbide, zirconium carbide, excess carbon containing zirconium carbide, boron carbide, excess carbon containing boron carbide.
12. The gas-impervious outer shell has a ceramic matrix encasing and bonding the reinforcement that is comprised of ceramic material formed by both pyrolysis of a ceramic forming polymer and silicon carbide or zirconium carbide ceramic material formed by chemical vapor deposition.
13. The gas-impervious inner tube down the center is composed of one or more of the following reinforcements imbedded in a ceramic matrix produced by the pyrolysis of one or more ceramic forming polymers: continuous fibers, chopped fibers, milled fibers, powder, platelets or whiskers.
14. The gas-impervious inner tube down the center contains reinforcement materials that are one or more of the following silicon carbide, zirconium carbide, graphite, titanium carbide, beryllium oxide, boron carbide, silicon nitride.
15. The gas-impervious inner tube down the center has a ceramic matrix encasing and bonding the reinforcement that is comprised of ceramic material formed by the pyrolysis of one or more ceramic forming polymers to create one or more of the following matrix/sealing materials: silicon carbide, excess carbon containing silicon carbide, zirconium carbide, excess carbon containing zirconium carbide, boron carbide, excess carbon containing boron carbide.
16. The gas-impervious inner tube down the center has a ceramic matrix encasing and bonding the reinforcement that is comprised of ceramic material formed by both pyrolysis of a ceramic forming polymer and silicon carbide or zirconium carbide ceramic material formed by chemical vapor deposition
17. The gas-impervious inner tube down the center has a thickness between 0.020 in. (0.5 mm) and 0.25 in. (6 mm).
18. The interior of the sphere or ovoid comprises a non-burning ceramic matrix with controlled nano-porosity and micro-porosity to contain fission products that would be released by failed fuel particles.
19. The interior matrix of the sphere or ovoid comprises one or more of a ceramic material produced by the pyrolysis of a pre-ceramic (ceramic forming) polymer in either inert gas or air, and a non-polymer derived ceramic reinforcement.
20. The interior of the sphere or ovoid where the ceramic matrix formed by pyrolysis of the pre-ceramic polymer is one or more of the following: silicon carbide, excess carbon containing silicon carbide, zirconium carbide, excess carbon containing zirconium carbide, boron carbide, excess carbon containing boron carbide, carbon, graphite.
21. The interior of the sphere or ovoid where the non-polymer-derived ceramic materials are one or more of the following: chopped fiber, milled fiber, powder, platelets, or whiskers.
22. The interior of the sphere or ovoid where the composition of the non-polymer-derived ceramic materials comprise one or more of the following: silicon carbide, silicon nitride, boron carbide, alumina, carbon, graphite, or titanium carbide.
23. The interior of the sphere or ovoid also contains selected amounts of neutron absorbing ceramic materials comprising one or more of the following: boron carbide, hafnium carbide, hafnium diboride, titanium diboride, erbium oxide and/or other high temperature ceramic materials known to absorb neutrons.
24. The interior of the sphere or ovoid also contains separate segments that contain large amounts of neutron reflecting ceramic materials including beryllium oxide, boron¹¹ carbide, and other ceramic materials known to function as neutron reflectors. The reflector segments would typically be placed near the inner or outer section of the interior matrix of the ceramic composite fuel sphere or ovoid.

Glossary

The following terms and definitions are provided to supplement any provided definition in the description, or any definition that may be inferred from context, and to provide further non-limiting examples.
ceramic composite: Can include ceramic fibers or other reinforcement material bonded together by a ceramic matrix (similar to fiberglass, only with ceramics instead of glass and plastic).
ceramic composite matrix: Can refer to a ceramic composite used to hold some other material within; one such example material being nuclear fuel particles.
ceramic forming polymer: Can refer to a material that is typically a liquid that can be cured like a plastic but when heated above 800° C. converts to a ceramic material instead or melting or burning.
ceramic matrix casing: Can refer to a ceramic composite or ceramic shell encasing a ceramic matrix.
controlled porosity: Can refer to porosity generated by varying the composition of the ceramic forming polymer, or by blending in ceramic powders of the appropriate size to form porosity when the ceramic forming polymer is converted to ceramic.
derived from pyrolysis of a ceramic forming polymer: Can refer to “formed”, “created”, or generated by heating (pyrolysis) of a ceramic forming polymer
gas-impervious: Can refer to having small enough pores or no pores that limit the penetration of gas through the material.
micro-porosity: Can refer to porosity not visible to the naked eye but visible under a light microscope
moderator: Can refer to a material that is used to slow neutrons in a nuclear reactor so that they are more efficient at causing fission of the fuel.
nano-porosity: Can refer to porosity that is difficult or impossible to see in a light microscope and is typically visible only with a scanning electron microscope (SEM).
non-polymer derived ceramic materials: Can refer to ceramic materials produce by some other process than polymer pyrolysis such as chemical vapor deposition, reaction bonding, melting, sintering, etc.
polymer precursors: Can refer to ceramic forming polymers.
radiation resistant high temperature ceramic material: Can refer to ceramic materials that either do not interact with nuclear radiation/neutrons, or can refer to material able to “heal” and revert back to its original structure after being damaged by radiation/neutrons.
ring: Can include the round or other shaped opening at the top and bottom of the shell that mates with the tube. Some embodiments can use alternate shapes for the opening (e.g. square, rectangular, elliptical, triangular and any other polygon) so long as the selected shape mates with tube to securely seal the cavity within the shell.
tube: Can include the round hollow cylinder that mates with the rings at the top and bottom of the shell. Some embodiments can use alternate shapes for the tube to mate with the ring (see definition of ring for example shapes).

1. A nuclear fuel containment system for encapsulating nuclear fuel particles, the containment system comprising:
a gas-impervious ceramic composite shell having a shell inner surface and a shell outer surface, the shell inner surface defining a cavity; and
a ceramic composite matrix having a controlled porosity provided within the cavity, the ceramic composite matrix containing the nuclear fuel particles therein.

2. The nuclear fuel containment system of claim 1 wherein the shell has a top portion and a bottom portion each defining a ring aligned about a center of the shell; and
further comprising a gas-impervious ceramic composite tube having a tube inner surface and a tube outer surface, a top portion of the tube and a bottom portion of the tube each sealed to a corresponding ring of the shell to further define the cavity between the shell inner surface and the tube outer surface.

3. The nuclear fuel containment system of claim 2 wherein the shell is any one of spherical, ovoidal and elliptical.

4. The nuclear fuel containment system of claim 3 wherein the ceramic composite matrix is comprised of at least one material formed by pyrolysis of a ceramic forming polymer.

5. The nuclear fuel containment system of claim 3 wherein the shell and the tube are comprised of a radiation resistant high temperature ceramic material.

6. The nuclear fuel containment system of claim 5 wherein the radiation resistant high temperature ceramic material is any one of the group comprising: silicon carbide (SiC); zirconium carbide (ZrC); and aluminum oxide.

7. The nuclear fuel containment system of claim 1 wherein the ceramic composite matrix is formed by pyrolysis of polymer precursors to produce any one of silicon carbide (SiC), zirconium carbide (ZrC), titanium carbide, silicon nitride, and aluminum oxide.

8. The nuclear fuel containment system of claim 1 wherein the ceramic composite matrix includes any one or more moderators and neutron absorbers uniformly distributed through the ceramic composite matrix.

9. The nuclear fuel containment system of claim 8 wherein the moderators are carbon and the neutron absorbers are one or more of boron carbide, hafnium carbide, hafnium diboride, erbium oxide or hafnium oxide.

10. The nuclear fuel containment system of claim 2 wherein at least one of the shell and the tube includes reinforcement materials in the form of any one of:
continuous fibers, chopped fibers, milled fibers, powder, platelets and whiskers.

11. The nuclear fuel containment system of claim 10 wherein the reinforcement materials are selected from any one of: silicon carbide, zirconium carbide, graphite, titanium carbide, beryllium oxide, boron carbide, and silicon nitride.

12. The nuclear fuel containment system of claim 10 wherein the reinforcement materials are bonded together by ceramic material formed by the pyrolysis of one or more ceramic forming polymers to form a ceramic matrix casing or shell.

13. The nuclear fuel containment system of claim 12 wherein the reinforcement materials are further bonded together and sealed by chemical vapor deposition of a ceramic material.

14. The nuclear fuel containment system of claim 12 wherein the ceramic matrix casing is comprised of any one of: silicon carbide, silicon carbide containing excess carbon, zirconium carbide, zirconium carbide containing excess carbon, boron carbide, and boron carbide containing excess carbon.

15. The nuclear fuel containment system of claim 1 wherein the ceramic composite matrix is non-burning.

16. The nuclear fuel containment system of claim 15 wherein the controlled porosity of the ceramic composite matrix includes nano-porosity and micro- porosity.

17. The nuclear fuel containment system of claim 15 wherein the ceramic composite matrix comprises a ceramic material produced by pyrolysis of a ceramic forming polymer mixed/blended or reacted with one or more non-polymer derived ceramic materials.

18. The nuclear fuel containment system of claim 15 wherein the ceramic material is one or more of: silicon carbide, silicon carbide containing excess carbon, zirconium carbide, zirconium carbide containing excess carbon, boron carbide, and boron carbide containing excess carbon.

19. The nuclear fuel containment system of claim 15 wherein the non-polymer derived ceramic materials are one or more of: chopped fibers, milled fibers, powder, platelets and whiskers.

20. The nuclear fuel containment system of claim 15 wherein the non-polymer derived ceramic materials is one or more of: silicon carbide, silicon nitride, boron carbide, alumina, carbon, graphite, and titanium carbide.

21. The nuclear fuel containment system of claim 15 wherein the ceramic composite matrix includes at least one neutron absorbing ceramic material.

22. The nuclear fuel containment system of claim 21 wherein neutron absorbing ceramic material is any one of: boron carbide, hafnium carbide, hafnium diboride, titanium diboride, and erbium oxide.

23. The nuclear fuel containment system of claim 15 wherein the ceramic composite matrix further comprises at least one neutron reflecting segment composed of neutron reflecting ceramic material.

24. The nuclear fuel containment system of claim 23 wherein the at least one neutron reflecting segment is adjacent to one of the outer tube surface and the inner shell surface.

25. A method of manufacturing a nuclear fuel containment system for encapsulating nuclear fuel particles, the method comprising:
providing ceramic fiber on a cylinder, a first half-shell mold and a second half-shell mold;
coating the ceramic fiber with a slurry of ceramic forming polymer and silicon carbide ceramic powder;
pyrolysing the coated ceramic fiber to produce two ceramic composite shell halves and a ceramic composite tube;
sealing the two ceramic composite shell halves and the ceramic composite tube; and
providing a ceramic composite matrix containing nuclear fuel particles within the two ceramic composite shell halves.
